(19) United States
(12) Patent Application Publication
(10) Pub. No.: US 2018/0107047 A1
(43) Pub. Date: Apr. 19, 2018

(54) Adhesive Tape, Fabricating Method Thereof, and Display Device

(71) Applicants: BOE Technology Group Co., Ltd., Beijing (CN); Beijing BOE Optoelectronics Technology Co., Ltd., Beijing (CN)

(72) Inventors: Qingping Yin, Beijing (CN); Haiwei Sun, Beijing (CN); Tingting Zhao, Beijing (CN); Caizheng Zhang, Beijing (CN); Xuerong Wang, Beijing (CN)

(73) Assignees: BOE Technology Group Co., Ltd., Beijing (CN); Beijing BOE Optoelectronics Technology Co., Ltd., Beijing (CN)

(21) Appl. No.: 15/522,513

(22) PCT Filed: Sep. 28, 2016
(86) PCT No.: PCT/CN2016/100667

§ 371 Date: Apr. 27, 2017

(30) Foreign Application Priority Data
Jan. 4, 2016 (CN) 201610005977.1

(51) Int. Cl. G02F 1/1333; F21V 8/00; G02F 1/1335; B32B 3/30

(52) U.S. Cl. CPC G02F 1/133308; G02B 6/0055; B32B 3/30; G02B 6/0091; G02F 1/133606; G02B 6/0088

(57) ABSTRACT

An adhesive tape and a fabricating method thereof, and a display device are provided. The adhesive tape includes a first release film, a first bonding layer, a base layer, a second bonding layer and a second release film stacked stacked on each other. A plurality of recesses are disposed in a surface of the first release film facing the first bonding layer and the first bonding layer includes a plurality of protrusions to fit into the plurality of recesses. The adhesive tape is used to bond the backlight module and the display panel of a display device together.

### TECHNICAL FIELD

Embodiments of the present disclosure relate to an adhesive tape and a fabricating method thereof, and a display device.

### BACKGROUND

A display device includes a display panel and a backlight module. The display panel is bonded to the sealant frame of the backlight module by an adhesive tape. The sealant frame is usually formed by cutting and thus has varying heights at different positions, so that the sealant frame cannot contact the adhesive tape in a large portion of area. As a result, the contact area and the cohesive force between the bonding layer of the adhesive tape and the sealant frame are relatively small, so that the display panel prone to separating from the backlight module.

### SUMMARY

Embodiments of the present disclosure provide an adhesive tape and a fabricating method thereof, and a display device.

According to at least one embodiment of the present disclosure, an adhesive tape is provided. The adhesive tape includes a first release film, a first bonding layer, a base layer, a second bonding layer and a second release film stacked on each other. A plurality of recesses are disposed in a surface of the first release film facing the first bonding layer and the first bonding layer includes a plurality of protrusions to fit into the plurality of recesses.

An embodiment of the present disclosure also provides a display device. The display device includes a backlight module and a display panel. The backlight module includes a sealant frame that has been processed by a surface corrosion process. The sealant frame of the backlight module is bonded to the first bonding layer of the adhesive tape and the peripheral region of the display panel is bonded to the second bonding layer of the adhesive tape.

An embodiment of the present disclosure also provides a method for fabricating the adhesive tape, including: providing a mould to prepare the first release film, the mould having a plurality of second protrusions disposed on its bottom to match the plurality of recesses in one-to-one correspondence; forming the first release film using the mould; forming the first bonding layer on the surface of the first release film having the plurality of recesses disposed therein; overlaying the base layer on the first bonding layer; forming the second bonding layer on the base layer; and overlaying the second release film on the second bonding layer.

### BRIEF DESCRIPTION OF THE DRAWINGS

Embodiments of the present disclosure will be described in more detail below with reference to accompanying drawings to allow an ordinary skill in the art to more clearly understand embodiments of the present disclosure, in which:

FIG. 1 is a schematic cross section view of a display device;

FIG. 2 is a schematic cross section view of an adhesive tape in an embodiment of the present disclosure;

FIG. 3 is a schematic diagram of a surface of a first release film facing a first bonding layer in an embodiment of the present disclosure;

FIG. 4 is a schematic cross section view of a display device in an embodiment of the present disclosure;

FIG. 5 is a schematic plan view of a first type of first protrusions in an embodiment of the present disclosure;

FIG. 6 is a schematic cross section view of the second type of first protrusions in an embodiment of the present disclosure;

FIG. 7 is a schematic cross section view of the third type of first protrusions in an embodiment of the present disclosure;

FIG. 8 is a schematic diagram illustrating the procedure of the test for adhesive force of the first bonding layer in an embodiment of the present disclosure; and

FIG. 9 is a flow chart of a fabricating method of an adhesive tape in an embodiment of the present disclosure.

### DETAILED DESCRIPTION

Technical solutions according to the embodiments of the present disclosure will be described clearly and fully as below in conjunction with the accompanying drawings of embodiments of the present disclosure. It is apparent that the described embodiments are just a part but not all of the embodiments of the disclosure. Based on the described embodiments herein, a person of ordinary skill in the art can obtain other embodiment(s), without any creative work, which shall be within the scope of the present disclosure.

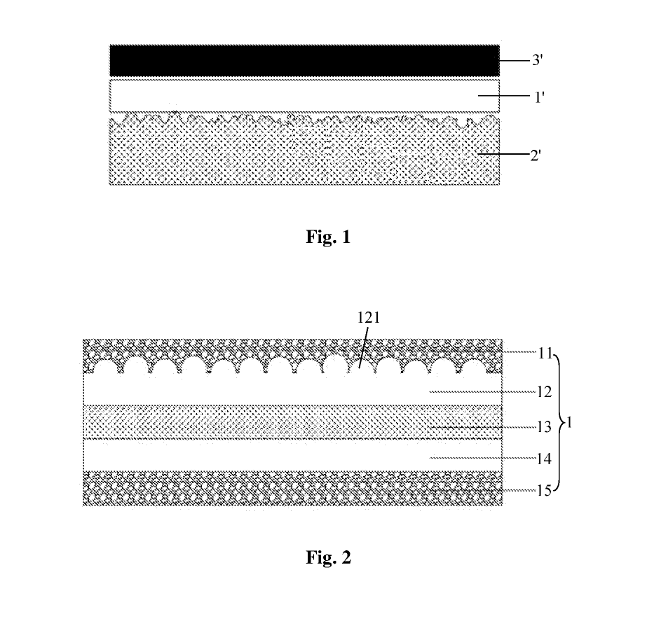

In the field of display technologies, one solution to reduce the variation of heights at different positions of a sealant frame is to process the sealant frame by a surface corrosion process (VDI) so as to bond contact area and the cohesive force between the bonding layer and the sealant frame. The inventor of the present application has realized that, as shown in FIG. 1, the surface of the sealant frame 1′ processed by the surface corrosion process is also uneven, and the bonding layer 2′ cannot gain contact with the sealant frame 1′ at the depressed portions, so that the cohesive force between the bonding layer 2′ and the sealant frame 1′ cannot satisfy requirements, and the bonding between the display panel 3′ and the backlight module is not robust enough.

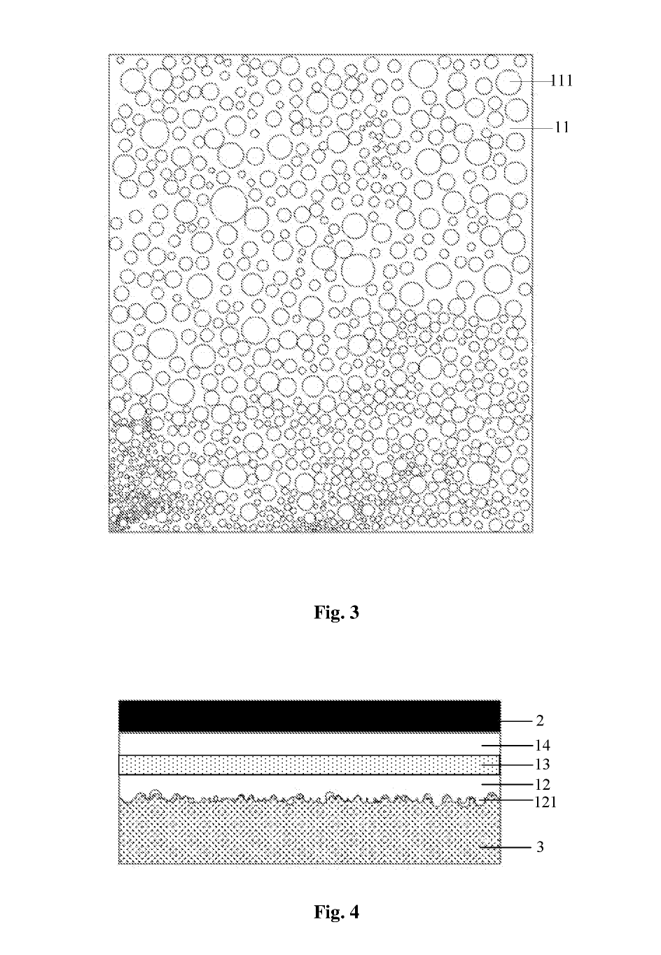

An embodiment of the present disclosure provides an adhesive tape. As shown in FIGS. 2 and 3, the adhesive tape 1 includes a release film 11, a first bonding layer 12, a base layer 13, a second bonding layer 14 and a second release film 15 stacked on each other. A plurality of recesses 111 are disposed in the surface of the first release film 11 facing the first bonding layer 12, and the first bonding layer 12 includes a plurality of protrusions 121 to fit into the plurality of recesses 111.

With the adhesive tape 1 provided in the embodiment of the present disclosure having the structure described above, the first bonding layer 12 may have a plurality of protrusions 121 after the first release film 11 is peeled off. When the backlight module and the display panel are bonded together by the adhesive tape 1, as shown in FIG. 4, the second bonding layer 14 of the adhesive tape 1 is bonded to the display panel 2, and the first bonding layer 12 of the adhesive tape 1 is bonded to the sealant frame 3 of the backlight module that has been processed by a surface corrosion process, in which the individual first protrusions 121 on the first bonding layer 12 may gain contact with the depressed portions of the sealant frame 3, so that the contact area and the cohesive force between the sealant frame 3 and the first bonding layer 12 are effectively increased, to allow the bonding of the display panel 2 and the backlight module to be more robust. The adhesive in the first bonding layer 12 has some flowability, even though the plurality of protrusions 121 on the first bonding layer 12 are not in one-to-one correspondence with the depressed portions of the sealant frame, the plurality of protrusions 121 can gain contact with the depressed portions of the sealant frame 3 under the pressure applied during the attaching operation, which increases the contact area between the sealant frame 3 and the first bonding layer 12.

It is noted that the structure of the second bonding layer 14 and the second release film 15 is not limited in the foregoing description and may be chosen by those of ordinary skills in the art according to actual requirements. During application of the adhesive tape 1, the first bonding layer 12 is used to adhere to the sealant frame 3 of the backlight module, and the second bonding layer 14 is used to adhere to the display panel 2, i.e. the second bonding layer 14 adheres to the glass substrate of the display panel 2 that has a very smooth surface. In this way, in an embodiment of the present disclosure, for example, as shown in FIG. 2, the surface of the second release film 15 facing the second bonding layer 14 is a flat surface to allow the surface of the second bonding layer 14 facing the second release film 15 to be a flat surface, so that the contact area and the cohesive force between the second bonding layer 14 and the display panel 2 are increased.

Moreover, the inventor of the present application found that when an existing adhesive tape is used to bond a backlight module and a display panel together, the bonding layer of the adhesive tape may experience great transverse deformation when being heated, wrinkles are occurred, which further reduces the cohesive force between the bonding layer and the sealant frame. To prevent this problem, in an embodiment of the present disclosure, for example, as shown in FIG. 3, every two adjacent recesses in the surface of the first release film 11 facing the first bonding layer 12 have a gap therebetween to allow every two adjacent protrusions 121 on the first bonding layer 12 to have a gap therebetween after the first release film 11 is peeled off. The gap can provide some space for the transverse deformation of the first protrusions 121, so that the transverse deformation of the first bonding layer 12 due to heat may be effectively reduced or even eliminated so as to prevent the problem of the reduced cohesive force between the first bonding layer 12 and the sealant frame 3 caused by the wrinkles of the first bonding layer 12.

Optionally, in an embodiment of the present disclosure, both the first release film 11 and the second release film 15 are polyester films, for example, PET (polyethylene terephthalate) films, so as to have advantages, such as good mechanical properties, high stiffness, hardness and toughness, resistance against puncture, friction, high temperature, low temperature, chemicals and oil, air tightness and good fragrance protectiveness. Optionally, the adhesives in the first bonding layer 12 and the second bonding layer 14 are all acrylic type adhesives to allow the first and second bonding layers to have advantages, such as high strength, resistance against shock and weathering, capability of oil-surface bonding, ease to use, strong resistance against impact and shear force, or the like. Optionally, the base layer 13 is a polyester film with good mechanical properties. It is noted that materials of the first release film 11, the first bonding layer 12, the base layer 13, the second bonding layer 14 and the second release film 15 are not limited to this material and can be chosen by those skilled in the art as required.

Moreover, if the thickness of the adhesive tape 1 is too thin, the first bonding layer 12 and the second bonding layer 14 of the adhesive tape 1 will have less adhesive incorporated therein, which may result in a smaller cohesive force between the first bonding layer 12 and the sealant frame 3 of the backlight module or between the second bonding layer 14 and the display panel 2, so that the backlight module will be prone to separating from the display panel 2. If the thickness of the adhesive tape 1 is too thick, the display device will have a large thickness, which prevents thinning of the display device. It is needed to set the thickness of the adhesive tape 1 properly. Exemplarily, in an embodiment of the present disclosure, the thickness of the adhesive tape 1 is in a range from 0.03 mm to 0.1 mm

For convenience of implementation by those skilled in the art, the way in which the recesses 111 arranged in the surface of the first release film 11 facing the first bonding layer 12 will be described in detail in an embodiment of the present disclosure hereafter.

Optionally, in an embodiment of the present disclosure, as shown in FIGS. 2 and 3, a plurality of recesses 111 of the same shape are disposed in the surface of the first release film 11 facing the first bonding layer 12, so that a simplified method can be used to prepare the first release film 11. For example, since the depressed portions of the sealant frame 3 of the backlight module usually have varying dimensions after the sealant frame 3 has been processed by a surface corrosion process, to further increase the contact area between first bonding layer 12 and the sealant frame 3, for example, a plurality of recesses 111 of the same shape and of at least two different dimensions are disposed in the surface of the first release film 11 facing the first bonding layer 12 and the plurality of protrusions 121 on the first bonding layer 12 to fit into the plurality of recesses 111 also have at least two different dimensions, so that the first protrusions 121 on the first bonding layer 12 can gain better contact with the depressed portions of the sealant frame 3. In an embodiment of the present disclosure, the plurality of recesses 111 disposed in the surface of the first release film 11 facing the first bonding layer 12 may also have different shapes.

In an embodiment of the present disclosure, the plurality of recesses 111 disposed in the surface of the first release film 11 facing the first bonding layer 12 may be distributed regularly or irregularly. For example, as shown in FIG. 3, The plurality of recesses 111 in the surface of the first release film 11 facing the first bonding layer 12 may be randomly distributed, so that the surface of the first release film 11 facing the first bonding layer 12 may have a higher roughness to increase the contact area between the first bonding layer 12 and the sealant frame 3 of the backlight module.

The shapes of the plurality of recesses 111 in the surface of the first release film 11 facing the first bonding layer 12 will be described in details below.

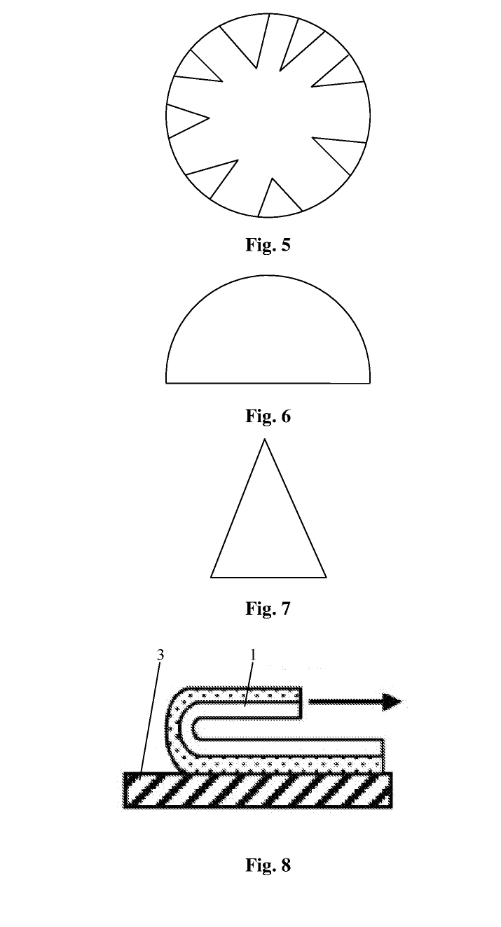

For example, the shape of the recesses 111 in the surface of the first release film 11 facing the first bonding layer 12 may be a shape like an octopus sucker as shown in FIG. 5, or a semi-spherical shape as shown in FIG. 6, or a conical shape as shown in FIG. 7. The shape of the recesses 111 in the surface of the first release film 11 facing the first bonding layer 12 is not limited to those described above and may also be other shapes. For example, in an embodiment of the present disclosure, the diameter of the openings of the recesses 111 may be in a range from 5 μm to 10 μm, and the depth of the recesses may be in a range from 5 μm to 10 μm to adapt the dimensions of the recesses 111 to those of the depressed portions of the sealant frame 3 processed by a surface corrosion process, which can further increase the contact area between the first bonding layer 12 and the sealant frame 3. For example, when the diameter of the openings of the recesses 111 is in a range from 5 μm to 10 μm, the distance between the symmetric axes of every two adjacent recesses 111 may range from 10 μm to 15 μm to leave a gap between the two adjacent recesses 111.

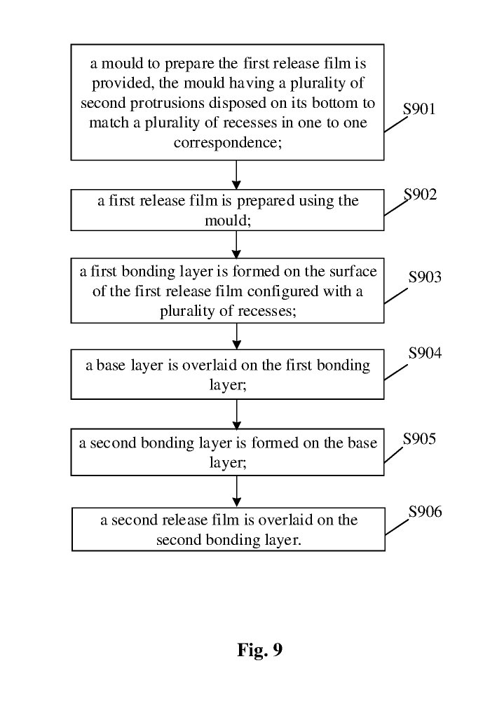

For those skilled in the art to better understand the advantages of the adhesive tape 1 in embodiments of the present disclosure, in an embodiment of the present disclosure, the bonding layer of an existing adhesive tape and the first bonding layer 12 of the adhesive tape 1 in the embodiment of the present disclosure are tested for their adhesive force in a manner shown in FIG. 8, in which the adhesive tape 1 in the embodiment of the present disclosure differs from the existing adhesive tape in that the first release film 11 of the adhesive tape 1 of the present embodiment has a plurality of recesses 111 and the first bonding layer 12 includes a plurality of protrusions 121 to fit into the plurality of recesses 111 with the plurality of recesses 111 each having a semi-spherical shape, a depth of 5 μm to 10 μm, and a diameter of 5 μm to 10 μm.

The test results of the adhesive force of the bonding layer of the existing adhesive tape and the adhesive force of the first bonding layer 12 of the adhesive tape 1 in the embodiment of the present disclosure are shown in table 1:

TABLE 1

| | Adhesive force (N/20 mm) | | |
|---|---|---|---|
| Type of adhesive tape | First test | Second test | Third test |
| Existing adhesive tape | 10.7 | 10.5 | 10.9 |
| Adhesive tape in an embodiment | 12.9 | 13.1 | 12.8 |
| of the present disclosure | | | |

As can be seen from table 1, compared with the existing adhesive tape, the adhesive tape 1 in an embodiment of the present disclosure enables the cohesive force between the first bonding layer 12 and the sealant frame 3 of the backlight module of the present embodiment to be improved significantly.

An embodiment of the present disclosure also provides a display device. As shown in FIG. 4, the display device includes a backlight module and a display panel 2. The backlight module includes a sealant frame 3 that has been processed by a surface corrosion process. The sealant frame 3 is bonded to the first bonding layer 12 of the adhesive tape 1 described above and the peripheral region of the display panel 2 is bonded to the second bonding layer 14 of the adhesive tape 1.

The display device provided in the embodiment of the present disclosure has the configuration described above, the individual first protrusions 121 on the first bonding layer 12 can contact the depressed portions of the sealant frame 3 that has been processed by a surface corrosion process, so that the contact area and the cohesive force between the sealant frame 3 and the first bonding layer 12 are effectively increased, so as to allow the bonding between the display panel 2 and the backlight module more robust and the structure of the display device more stable.

An embodiment of the present disclosure provides a fabricating method of an adhesive tape to prepare the adhesive tape described above. For example, the fabricating method includes the following steps.

Step S901, a mould to prepare the first release film is provided, the mould having a plurality of second protrusions disposed on its bottom to match a plurality of recesses in one-to-one correspondence;

Step S902, a first release film is prepared using the mould;

Step S903, a first bonding layer is formed on the surface of the first release film configured with a plurality of recesses;

Step S904, a base layer is overlaid on the first bonding layer;

Step S905, a second bonding layer is formed on the base layer; and

Step S906, a second release film is overlaid on the second bonding layer.

The fabricating method of an adhesive tape provided in the embodiment of the present disclosure includes the steps described above to prepare an adhesive tape having the structure described above, the fabricating method of an adhesive tape has the same beneficial effects as the adhesive tape described above and no details will be repeated here.

The described above are only exemplary embodiments of the present disclosure, and the present disclosure is not intended to be limited thereto. For one of ordinary skill in the art, various changes and alternations may be made without departing from the technical scope of the present disclosure, and all of these changes and alternations shall fall within the scope of the present disclosure.

The present application claims priority to the Chinese patent application No. 201610005977.1 filed on Jan. 4, 2016 and entitled “Adhesive Tape, Fabricating Method Thereof, And Display Device,” the disclosure of which is incorporated herein in its entirety by reference.

1. An adhesive tape, comprising a first release film, a first bonding layer, a base layer, a second bonding layer and a second release film stacked on each other, wherein a plurality of recesses are disposed in a surface of the first release film facing the first bonding layer and the first bonding layer comprises a plurality of protrusions to fit into the plurality of recesses.

2. The adhesive tape according to claim 1, wherein the plurality of recesses of the first release film are of the same shape.

3. The adhesive tape according to claim 2, wherein the plurality of recesses with same shape have at least two different dimensions.

4. The adhesive tape according to claim 1, wherein the plurality of recesses are randomly distributed in the surface of the first release film facing the first bonding layer.

5. The adhesive tape according to claim 4, wherein the recesses have a shape of an octopus sucker, a hemisphere, or a cone.

6. The adhesive tape according to claim 5, wherein openings of the recesses have a diameter in a range from 5 μm to 10 μm.

7. The adhesive tape according to claim 5, wherein the recesses have a depth in a range from 10 μm to 10 μm.

8. The adhesive tape according to claim 1, wherein every two adjacent recesses have a gap therebetween.

9. The adhesive tape according to claim 1, wherein a surface of the second release film facing the second bonding layer is a flat surface.

10. The adhesive tape according to claim 1, wherein both the first release film and the second release film are polyester films, the adhesives in the first bonding layer and the second bonding layer are acrylic adhesives, and the base layer is a polyester film.

11. The adhesive tape according to claim 1, wherein the tape has a thickness in a range from 0.03 mm to 0.1 mm.

12. A display device comprising a backlight module and a display panel, the backlight module comprising a sealant frame that has been processed by a surface corrosion process, wherein the sealant frame of the backlight module is bonded to the first bonding layer of the adhesive tape and the peripheral region of the display panel is bonded to the second bonding layer of the adhesive tape according to claim 1.

13. A method for fabricating the adhesive tape according to claim 1, comprising:
providing a mould to prepare the first release film, the mould having a plurality of second protrusions disposed on its bottom to match the plurality of recesses in one-to-one correspondence;
forming the first release film using the mould;
forming the first bonding layer on the surface of the first release film having the plurality of recesses disposed therein;
overlaying the base layer on the first bonding layer;
forming the second bonding layer on the base layer; and
overlaying the second release film on the second bonding layer.

14. The adhesive tape according to claim 2, wherein the plurality of recesses are randomly distributed in the surface of the first release film facing the first bonding layer.

15. The adhesive tape according to claim 3, wherein the plurality of recesses are randomly distributed in the surface of the first release film facing the first bonding layer.

16. The adhesive tape according to claim 15, wherein every two adjacent recesses have a gap therebetween.

17. The adhesive tape according to claim 2, wherein both the first release film and the second release film are polyester films, the adhesives in the first bonding layer and the second bonding layer are acrylic adhesives, and the base layer is a polyester film.

18. The adhesive tape according to claim 3, wherein both the first release film and the second release film are polyester films, the adhesives in the first bonding layer and the second bonding layer are acrylic adhesives, and the base layer is a polyester film.
